(19) United States
(12) Patent Application Publication
(10) Pub. No.: US 2026/0092402 A1
(43) Pub. Date: Apr. 2, 2026

(54) PREPARATION OF ULTRAFINE POLYIMIDE NANOFIBER MEMBRANE AT HIGH VOLTAGE AND USE OF MEMBRANE IN HIGH-TEMPERATURE FILTRATION

(71) Applicant: University of South China, Hengyang (CN)

(72) Inventors: Dong XIE, Hengyang (CN); Chen YANG, Hengyang (CN); Suzhe LI, Hengyang (CN); Chenhua WANG, Hengyang (CN)

(73) Assignee: University of South China, Hengyang (CN)

(21) Appl. No.: 19/344,455

(22) Filed: Sep. 29, 2025

(30) Foreign Application Priority Data
Sep. 30, 2024 (CN) 202411388551.X

(51) Int. Cl. D01F 11/08; B01D 46/54; B01D 67/00; B01D 69/02; B01D 71/64; D01D 1/02; D01D 5/00; D01F 6/60; D04H 1/4326; D04H 1/4382; D04H 1/728

(52) U.S. Cl. CPC D01F 11/08; B01D 46/543; B01D 67/0006; B01D 69/02; B01D 71/64; D01D 1/02; D01D 5/0061; D01F 6/605; D04H 1/4326; D04H 1/43838; D04H 1/728; B01D 2323/081; B01D 2323/39; D10B 2331/14; D10B 2505/04

(57) ABSTRACT

The present invention discloses preparation of an ultrafine polyimide nanofiber membrane at high voltage and use of the membrane in high-temperature filtration. By using a metal wire needleless-type electrospinning technology, a nanofiber membrane with an average fiber diameter of lower than 130 nm is prepared at a high voltage of 80 kV Such a fine fiber structure not only enhances interception efficiency for fine particulate matter (PM0.3) to achieve a filtration efficiency of above 99.97%, but also significantly reduces filtration resistance to 189.18 Pa through a slip effect, thus having better performance than conventional commercial glass fiber filtration materials. The ultrafine polyimide nanofiber membrane prepared by the present invention has the advantages of high filtration efficiency, low resistance, good thermal stability, and hydrophobicity, thus having a broad application prospect in the field of high-temperature filtration of PM.

### CROSS-REFERENCE TO RELATED APPLICATIONS

The application claims priority to Chinese patent application No. 202411388551.X, filed on Sep. 30, 2024, the entire contents of which are incorporated herein by reference.

### TECHNICAL FIELD

The present invention relates to the technical field of separation membranes, and particularly relates to preparation of an ultrafine polyimide nanofiber membrane at high voltage and use of the membrane in high-temperature filtration.

### BACKGROUND

Emission of fine particulate matter (PM2.5-0.3) caused by industrialization and urbanization has become an environmental issue to be addressed urgently. PM2.5-0.3 is mainly derived from combustion of fossil fuels, biomass, and waste, and these activities are commonly found in industry, transportation, agriculture, and domestic heating. PM has complex composition, including inorganic substances such as silicates, sulfates, and nitrates, and organic substances such as organic carbon and elemental carbon, and may carry up to 791 bacterial genera, thereby increasing allergy and infection risks. Negative charge characteristics of PM affect its behaviors in the atmosphere.

PM poses a serious threat to human health. PM2.5, due to a small size, enters the human body more easily, thereby causing more severe diseases, such as asthma, cardiovascular diseases, and pulmonary inflammation. Studies have shown that when the concentration of PM2.5 exceeds 200 μg/m³, the number of outpatients in the respiratory department is increased significantly. PM0.3, due to a smaller particle size, may lead to cardiovascular diseases, diseases of the respiratory system, diabetes mellitus, and lung cancer.

Industrial dust collectors are effective for large particles, but are ineffective for the particulate matter smaller than 2.5 μm. Electrostatic dust collectors have high costs, and their removal efficiency is affected by characteristics of PM. Nanofiber filters, due to a “slip effect,” reduce airflow resistance, thus having higher filtration efficiency and lower pressure drop compared with general ultrafine fiber filters, and showing potential in removal of the particulate matter smaller than 2.5 μm. Polyimide (PI), with a rigid chain segment, a strong intermolecular interaction, and high binding energy, has exhibited excellent mechanical properties. A highly conjugated and highly aromatic structure endows the PI with good thermal stability, and due to its relatively high dipole moment (6.2 D), an adsorption capability to the particulate matter is enhanced, thereby making the PI become a preferred high-performance material in the field of air filtration.

In the article “High Temperature Resistant Polyimide/Polyethersulfone Nano-Fibers Membrane for Removal of PM”, a PI/PES nanofiber membrane developed by Wei-Ting Chen and Yi-Hung Lai reaches a filtration efficiency of 99.54% for PM2.5 within a spinning time of 20 minutes, has a pressure drop of 92 Pa, and has remarkable thermal stability at approximately 500° C. In the article “Electrospun Polyimide/Metal-Organic Framework Nanofibrous Membrane with Superior Thermal Stability for Efficient PM2.5 Capture”, a PI-ZIF nanofiber membrane prepared by combining the PI and a metal-organic framework (ZIF-8) in ZhiminHao's team reaches a filtration efficiency of 96.6%±2.9% for PM2.5 at 300° C., and exhibits good thermal stability and low pressure drop.

Although the polyimide has made significant progress in filtration of PM2.5, it still needs to be improved in filtration efficiency for PM0.3. Moreover, in conventional electrospinning technologies, an electrospinning time for electrospinning PI nanofiber membranes within a commonly used voltage range of 10 kV to 40 kV often exceeds 60 min. The complexity of preparation processes also affects economic applicability and scalability of materials in industrial applications.

### SUMMARY

An objective of the present invention is to provide preparation of an ultrafine polyimide nanofiber membrane at high voltage and use of the membrane in high-temperature filtration, so as to address the issues of still poor filtration efficiency for PM0.3 and complex preparation processes of polyimide materials described above. In the present invention, a metal wire needleless-type electrospinning process is adopted for electrospinning a PI nanofiber membrane. Compared with a needle-type electrospinning process, the needleless-type electrospinning solution avoids the issues of needle clogging and wear. In the present invention, a voltage of 60 kV to 80 kV is used to enhance a droplet splitting capability and generate nanofibers with a smaller diameter, thereby improving filtration performance for high-temperature filtration. Compared with composite materials, the present invention prepares a fine-diameter nanofiber membrane by adjusting the electrospinning voltage to improve the filtration performance of the PI nanofiber membrane more conveniently. With the aid of the metal wire needleless-type electrospinning process, electrospinning of the fine-diameter PI nanofiber membrane can be completed within 8-12 min to obtain a high-efficiency filtration membrane.

To achieve the above objective, a first aspect of the present invention provides a method for preparing an ultrafine polyimide nanofiber membrane, which includes the following steps:
(1) formulation of a polyamic acid solution:
dissolving 4,4′-oxydianiline in N,N-dimethylacetamide to obtain a transparent 4,4′-oxydianiline/N,N-dimethylacetamide solution after the 4,4′-oxydianiline (ODA) is completely dissolved; and adding a pyromellitic dianhydride monomer into the 4,4′-oxydianiline/N,N-dimethylacetamide solution in multiple portions, stirring the solution to enable a full reaction between the 4,4′-oxydianiline and the pyromellitic dianhydride monomer, and allowing to stand to obtain the polyamic acid solution;
(2) subjecting the polyamic acid solution to electrospinning using a metal wire-type needleless process; and
(3) after completion of the electrospinning, performing drying to obtain a polyamic acid (PAA) nanofiber membrane, and then performing thermal imidization to obtain a polyimide nanofiber membrane.

Preferably, a formulation process of the solution in the step (1) is carried out under a nitrogen protection condition at 0-5° C.

Preferably, in the step (1), the 4,4′-oxydianiline (ODA), the N,N-dimethylacetamide (DMAc), and the pyromellitic dianhydride monomer (PMDA) are subjected to vacuum drying at 120° C. for 1-5 h to remove a remainder of a solvent and moisture.

PAA in the present invention refers to polyamic acid, SE refers to an electrospinning electrode, CE refers to a collecting electrode, PMDA refers to pyromellitic dianhydride, ODA refers to 4,4′-oxydianiline, and DMAC refers to N,N-dimethylacetamide.

Preferably, a molar ratio of the ODA to the PMDA in the step (1) is 1:(1-1.02).

Preferably, the PAA solution in the step (1) has a concentration of 15-20 wt %.

More preferably, the PAA solution in the step (1) has the concentration of 16-18 wt %.

Preferably, the metal wire-type needleless electrospinning process in the step (2) is adopted as follows: a voltage is 60-80 kV, a distance from an electrospinning electrode to a carrier is 240 mm, and a distance from a collecting electrode to the carrier is 20 mm; an operating distance of a pipetting cart is 350 mm, a cycle time is 6 s, and an electrospinning time is 8-12 min; and a spinning temperature is 15° C.-25° C., and humidity is 30%-50%.

Preferably, the drying in the step (3) is performed at a temperature of 100-120° C. for a time of 8-15 h.

Preferably, the thermal imidization in the step (3) includes specific steps as follows:
placing the dried PAA nanofiber membrane in a muffle furnace, heating from room temperature to 350-400° C. at 1-2° C./min under air conditions, performing heat preservation respectively at 100° C., 200° C., 300° C., and 350° C. for 1 h, and then naturally cooling to room temperature to obtain the polyimide nanofiber membrane.

A second aspect of the present invention provides an ultrafine polyimide nanofiber membrane, which is prepared by the above preparation method.

Preferably, the polyimide nanofiber membrane has an average fiber diameter of 100-400 nm.

A third aspect of the present invention provides use of an ultrafine polyimide nanofiber membrane, specifically use of a polyimide nanofiber membrane in high-temperature filtration of fine particulate matter.

Preferably, the fine particulate matter has a particle size of 0.3 μm.

Therefore, after adopting the preparation of an ultrafine polyimide nanofiber membrane at high voltage and the use of the membrane in high-temperature filtration described above, the present invention has the following beneficial effects.
(1) By adopting the metal wire-type needleless electrospinning technology for electrospinning of a polyimide (PI) material in the present invention, the nanofiber membrane with the average fiber diameter of 122 nm is prepared at a high electrospinning voltage of 80 kV within 10 min.
(2) The fine-diameter PI nanofiber membrane prepared and obtained by the present invention achieves a filtration efficiency of 99.98% for PM0.3, and meanwhile, operates at a low resistance of 189.18 Pa. After continuous treatment at a high temperature of 390° C. for one hour, the fine-diameter PI nanofiber membrane still maintains the filtration efficiency of above 99.95% for PM0.3, and is capable of achieving complete filtration of PM2.5. It is proven that the fine-diameter PI nanofiber membrane has excellent stability and reliability under extreme temperature conditions.
(3) The membrane prepared by the present invention also exhibits outstanding hydrophobicity, with a static hydrophobic angle measurement value of 130±3°, thereby being conducive to maintaining its filtration performance in a humid environment.
(4) The fine-diameter PI nanofiber membrane studied in the present invention provides a new preparation strategy for filtration of PM in a high-temperature environment, and offers new insights into its ultimate performance.

The technical solutions of the present invention are further described in detail below with reference to the accompanying drawings and examples.

### BRIEF DESCRIPTION OF DRAWINGS

FIG. 1(a) shows a flow chart of a preparation technology for a polyimide nanofiber membrane of the present invention;

FIG. 1(b) shows a schematic diagram of a spinning process of the polyimide nanofiber membrane of the present invention;

FIG. 2 shows characterization results of Examples 1-5, in which (a) is a Fourier transform infrared spectrometer (FTIR) chart of PAA and PI, (b) is a tensile stress-strain curve chart, (c) is a comparison chart of appearance before and after bending, and (d) is a principal chart of a slip flow effect;

FIG. 3 shows scanning electron microscopy (SEM) images and diameter distribution statistical charts of polyimide nanofiber membranes prepared in Examples 1-3 and Example 6, in which (a) and (b) are SEM images of PI15-80-10, (c) is an SEM image of PI16-80-10, (d) is a diameter distribution statistical chart of PI16-80-10, (e) is an SEM image of PI17-80-10, (f) is a diameter distribution statistical chart of PI17-80-10, (g) is an SEM image of PI18-80-10, and (h) is a diameter distribution statistical chart of PI18-80-10;

FIG. 4 shows filtration performance of Examples 1-3 and Examples 7-10, in which (a) is a chart showing filtration efficiency of PI nanofiber membranes prepared in Examples 1-3 and Examples 7-10 for PM0.3, (b) is a chart showing filtration efficiency of the PI nanofiber membranes prepared in Examples 1-3 and Examples 7-10 for PM0.5-2.5, (c) is a chart showing filtration efficiency of Example 1 and a commercial glass fiber for PM0.3, and (d) is a chart showing filtration efficiency of Example 1 and a commercial glass fiber for PM0.5-2.5;

FIG. 5 shows high temperature resistance, filtration performance, and hydrophobicity of Example 1, Examples 3-5, and Examples 11-14, in which (a) shows a thermogravimetric analysis (TG) chart, a differential thermogravimetric analysis (DTG) curve, and a differential scanning calorimetry (DSC) curve of a fine-diameter PI nanofiber membrane in Example 3, (b) is a chart showing filtration efficiency of the fine-diameter PI nanofiber membrane in Example 3 and a commercial glass fiber after treatment at different temperatures for PM0.3, (c) is a chart showing filtration efficiency of fine-diameter PI nanofiber membranes in Example 1, Examples 4-5, and Examples 11-14 for PM0.5-2.5, and (d) is a comparison chart of water contact angles on surfaces of fine-diameter PT nanofiber membranes and a commercial glass fiber after treatment at different temperatures; and

FIG. 6 shows SEM images and fiber diameter distribution statistical charts of PI nanofiber membranes prepared in Example 1 and Examples 4-5, in which (a) is an SEM image of PI350, (b) is a diameter distribution statistical chart of PI350, (c) is an SEM image of P380, (d) is a diameter distribution statistical chart of P380, (e) is an SEM image of P400, and (f) is a diameter distribution statistical chart of P400.

### DETAILED DESCRIPTION OF EMBODIMENTS

The present invention is further described below. It should be noted that detailed embodiments and specific operation processes are provided in the examples based on the technical solutions, but the present invention is not limited to the examples.

### Example 1

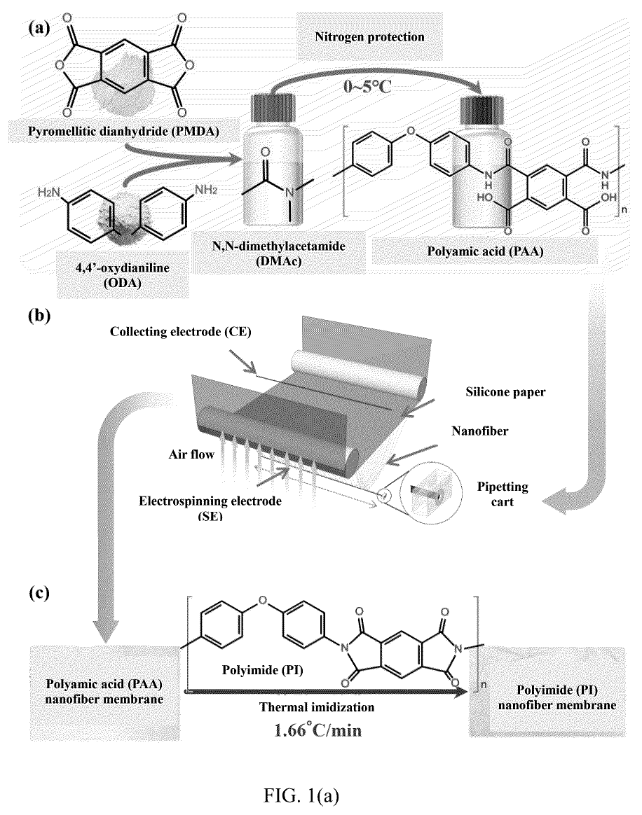

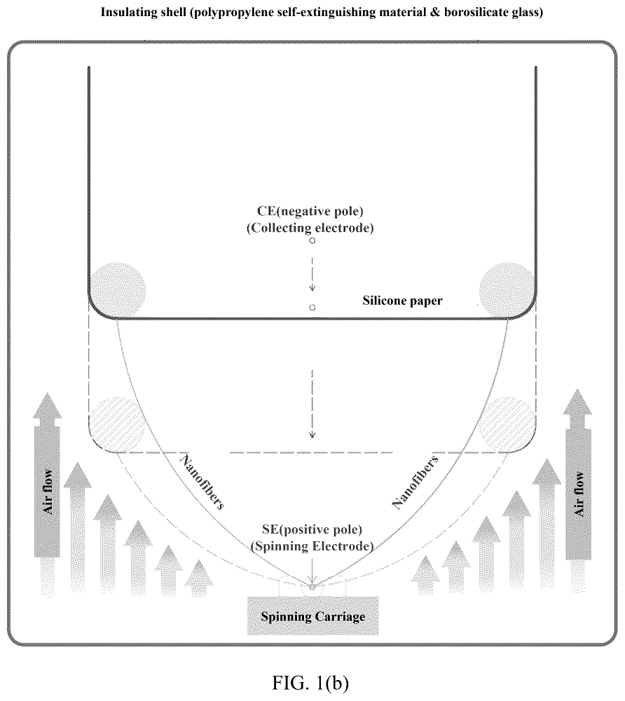

As shown in FIG. 1(a) and FIG. 1(b), a method for preparing an ultrafine polyimide nanofiber membrane includes the following steps:
(1) formulation of a PAA solution:
subjecting ODA, DMAc, and a PMDA monomer to vacuum drying at 120° C. for 1-5 h to remove a remainder of a solvent and moisture;
under a nitrogen protection condition, dissolving the ODA in the DMAc at a molar ratio of 1:1 to obtain a transparent ODA/DMAc solution after the ODA is completely dissolved; and
at 2° C., adding the PMDA monomer into the ODA/DMAc solution in three portions at an interval of 30 min each time, stirring the solution to enable a full reaction between the ODA and the PMDA monomer, and allowing to stand to obtain a PAA solution with a concentration of 18 wt %;
(2) electrospinning of the PAA solution:
performing electrospinning under the following parameters: a voltage of 80 kV, a distance from SE to a carrier being 240 mm, and a distance from CE to the carrier being 20 mm; an operating distance of a spinning carriage being 350 mm, a cycle time of 6 s, and an electrospinning time of 10 min; and a spinning temperature of 20° C., and humidity of 40%; and
(3) after completion of the electrospinning, performing drying at 120° C. for 12 h to obtain a PAA precursor, placing the dried PAA precursor in a muffle furnace, heating from room temperature to 350° C. at 1.66° C./min under air conditions, performing heat preservation respectively at 100° C., 200° C., 300° C., and 350° C. for 1 h, then naturally cooling to room temperature to thermally imidize the PAA precursor into a PI nanofiber membrane, and designating the obtained polyimide nanofiber membrane as PI18-80-10 or PI350.

### Example 2

The difference between this example and Example 1 is that the concentration of the PAA solution is different. In this example, the concentration of the PAA solution is 17 wt %, and an obtained polyimide nanofiber membrane is designated as PI17-80-10.

### Example 3

The difference between this example and Example 1 is that the concentration of the PAA solution is different. In this example, the concentration of the PAA solution is 16 wt %, and an obtained polyimide nanofiber membrane is designated as PI16-80-10.

### Example 4

The difference between this example and Example 1 is that the thermal imidization temperature is different. In this example, the muffle furnace is heated from room temperature to 380° C., and an obtained polyimide nanofiber membrane is designated as PI380.

### Example 5

The difference between this example and Example 1 is that the thermal imidization temperature is different. In this example, the muffle furnace is heated from room temperature to 400° C., and an obtained polyimide nanofiber membrane is designated as PI400.

### Example 6

The difference between this example and Example 1 is that the concentration of the PAA solution is different. In this example, the concentration of the PAA solution is 15 wt %, and an obtained polyimide nanofiber membrane is designated as PI15-80-10.

### Example 7

The difference between this example and Example 3 is that the electrospinning time is different. In this example, the electrospinning time is 12 min, and an obtained polyimide nanofiber membrane is designated as PI16-80-12.

### Example 8

The difference between this example and Example 3 is that the electrospinning time is different. In this example, the electrospinning time is 8 min, and an obtained polyimide nanofiber membrane is designated as PI16-80-8.

### Example 9

The difference between this example and Example 3 is that the electrospinning voltage is different. In this example, the electrospinning voltage is 70 kV, and an obtained polyimide nanofiber membrane is designated as PI16-70-10.

### Example 10

The difference between this example and Example 3 is that the electrospinning voltage is different. In this example, the electrospinning voltage is 60 kV, and an obtained polyimide nanofiber membrane is designated as PI16-60-10.

### Example 11

The difference between this example and Example 1 is that the thermal imidization temperature is different. In this example, the muffle furnace is heated from room temperature to 360° C., and an obtained polyimide nanofiber membrane is designated as PI360.

### Example 12

The difference between this example and Example 1 is that the thermal imidization temperature is different. In this example, the muffle furnace is heated from room temperature to 370° C., and an obtained polyimide nanofiber membrane is designated as PI370.

### Example 13

The difference between this example and Example 1 is that the thermal imidization temperature is different. In this example, the muffle furnace is heated from room temperature to 390° C., and an obtained polyimide nanofiber membrane is designated as PI390.

### Example 14

The difference between this example and Example 1 is that the thermal imidization temperature is different. In this example, the muffle furnace is heated from room temperature to 410° C., and an obtained polyimide nanofiber membrane is designated as PI410.

### Test Example

(1) FTIR and SEM characterization were performed on the polyimide nanofiber membranes prepared in Examples 1-5.

Molecular structures of synthesized materials were characterized using a Thermo Fisher Scientific Nicolet iS20 Fourier transform infrared spectrometer of the United States. Fourier transform infrared spectroscopy (FTIR) is used to identify functional groups and chemical bonds in a material to determine whether a target nanofiber membrane is obtained.

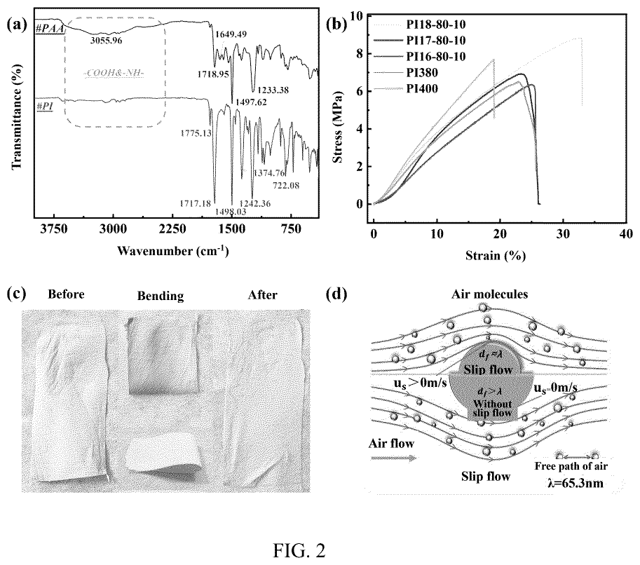

Detailed chemical composition analysis was performed on PAA nanofibers and thermally imidized PI nanofiber membranes by FTIR. As shown in FIG. 2(a), PAA has characteristic absorption peaks located at 1718.95 cm⁻¹ (asymmetric stretching vibration of C═O in COOH), 1649.49 cm⁻¹ (symmetric stretching vibration of C═O in CONH), 1497.62 cm⁻¹ (stretching vibration of a benzene ring skeleton), and 1233.38 cm⁻¹ (symmetric stretching vibration of CO—NH), which are consistent with a structural formula of PAA. After thermal imidization, PI has characteristic absorption peaks appeared at 1717.18 cm⁻¹ (asymmetric stretching vibration of C═O on an imide ring), 1775.13 cm⁻¹ (symmetric stretching vibration of C═O), and 1374.76 cm⁻¹ (stretching vibration of C—N—C on the imide ring), as well as 1242.36 cm⁻¹ (vibration of an ether bond) and 722.08 cm⁻¹ (bending vibration of —C═O in the imide ring). In addition, absorption peaks at 2600 cm⁻¹ to 3500 cm⁻¹ are attributed to —COOH and —NH— of PAA, which disappear in an FTIR spectrum of PI, indicating that PAA is completely converted into PI after the thermal imidization.

The morphology of samples was examined using a TESCAN MIRA LMS scanning electron microscope (SEM) of Czech Republic. Before SEM imaging, the samples were subjected to platinum spraying treatment for 45 s (at a current of 10 mA) using an Oxford Quorum SC7620 sputtering coating instrument to enhance the resolution and contrast of images. SEM analysis provides detailed views of the surface morphology and microstructure of the samples.

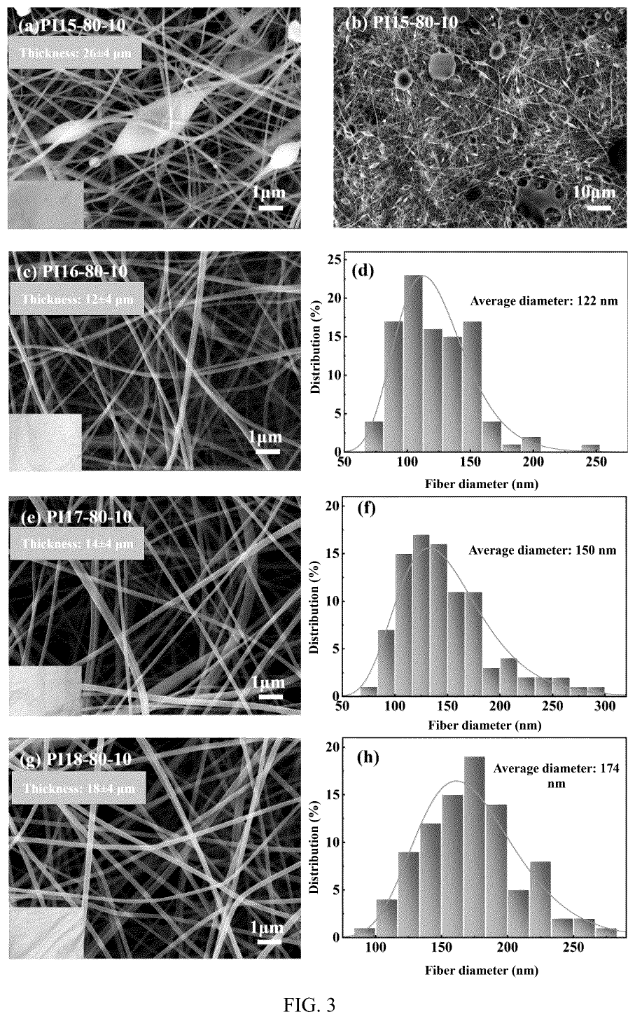

Surface morphology analysis was performed on nanofiber membranes prepared with PAA solutions of different concentrations using scanning electron microscopy (SEM). As shown in FIGS. 3(c), (e), and (g), when the concentration of the PAA solution is 16 wt. % to 18 wt. %, the obtained fine-diameter PI nanofiber membranes have extremely smooth surfaces without bead-like fibers observed, indicating that optimization of electrospinning process parameters is conducive to obtaining uniform fiber morphology. However, when the concentration of the PAA solution is 15 wt. %, it is observed in FIGS. 3(a) and (b) that a spindle-like structure and a bonding phenomenon appear on a fiber surface, due to unstable fiber formation caused by a lower solution concentration. SEM images were quantified through further statistical analysis. Results show that as the concentration of the PAA solution increases, average diameters of nanofibers also increase accordingly. Specifically, as shown in FIGS. 3(d), (f), and (h), diameter distributions of nanofibers all exhibit an inverse Gaussian distribution, and the average diameter values of the PI16-80-10, PI17-80-10, and PI18-80-10 nanofibers are 139.28 nm, 150.90 nm, and 174.27 nm, respectively. The membranes obtained in the present invention exhibit smaller fiber diameters, and this characteristic has a positive influence on improving filtration performance.

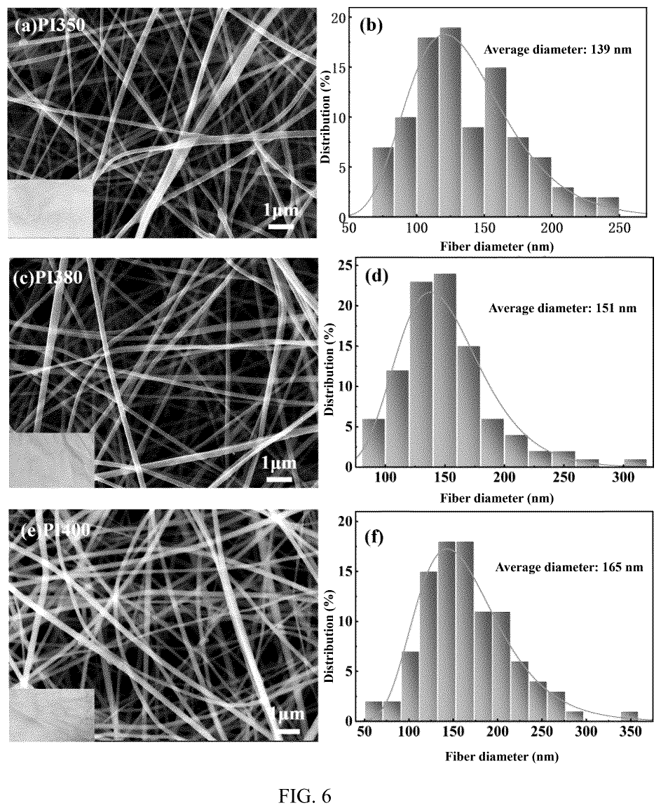

Surface morphology analysis was performed on fine-diameter PI nanofiber membranes treated at different temperatures using SEM. As shown in FIGS. 6(a), (c), and (e), even after further treatment at high temperature, fiber surfaces still remain smooth without structural damage caused by bending or curling. Further statistical analysis shows that as the treatment temperature increases, average diameters of nanofibers also increase accordingly. Specifically, as shown in FIGS. 6(b), (d), and (f), the average diameters of the PI350, PI380, and PI400 nanofibers are 139.28 nm, 151.41 nm, and 165.65 nm, respectively, and their diameter distributions all exhibit inverse Gaussian characteristics.
(2) Samples of fine-diameter PT nanofiber membranes were cut into rectangular specimens with a uniform dimension, that is, 30 mm in length and 10 mm in width. This standardized sample dimension is conducive to ensuring the consistency and comparability of test results. Subsequently, a tensile test was carried out on an INSTRON 8872 testing machine. During the test, the samples were stretched uniformly at a strain rate of 2 mm/min until the samples were fractured.

As shown in FIG. 2(b), as the PAA concentration increases from 16 wt. % to 18 wt. %, the tensile strength of the fine-diameter PI nanofiber membranes is increased significantly. Specifically, the PI18-80-10 sample exhibits the highest tensile strength, reaching 8.893 MPa, which is increased by 28.53% compared with 6.355 MPa of the PI16-80-10 sample. This result indicates that increasing the PAA concentration is an effective way to improve the mechanical strength of the PI nanofiber membranes. Further analysis indicates that as shown in FIGS. 3(c), (e), and (g), as the PAA concentration increases, the output of filaments is increased during electrospinning, resulting in an increase in the thickness of the nanofiber membranes prepared within the same electrospinning time. In addition, increasing the PAA concentration also leads to a decrease in the diameter of nanofibers, which has an influence on the tensile strength of the fine-diameter PI nanofiber membranes. The fine-diameter PI nanofiber membranes obtained in the present invention have a tensile strength of 5-8 MPa.

In addition, a Knudsen number (Kₙ) may be calculated through the following formula:

$$K n = 2 λ / {d}_{f}$$

where λ and d_{f} refer to a mean free path of air molecules (λ=65.3 nm) and a fiber diameter, respectively.

Corresponding Kₙ values of the PI16-80-10, PI17-80-10, and PI18-80-10 nanofiber membranes are 0.937, 0.865, and 0.749, respectively. Air flow around the fine-diameter PI nanofibers belongs to a transition flow region. As shown in FIG. 2(d), according to the principle of a slip flow phenomenon, when the fiber diameter approaches 65.3 nm, the air flow speed on the surface of a single fiber is not zero. Therefore, the resistance of air flow can be significantly decreased, and it can be reasonably assumed that the fine-diameter PT nanofiber membranes exhibit characteristics of a lip-shaped effect, especially for PI16-80-10.

According to calculated Kₙ values, air flow characteristics of the PI16-80-10, PI17-80-10, and PI18-80-10 nanofiber membranes were evaluated. The Kₙ values of these membranes are 0.937, 0.865, and 0.749, respectively, indicating that the air flow around the fine-diameter PI nanofibers is in a transition flow region. Based on the principle of the slip flow phenomenon, when the fiber diameter approaches the mean free path of air molecules, the air flow speed on the surface of a single fiber is not expected to approach zero.

From the perspective of mechanical properties shown in FIG. 2(b), an increase in ambient temperature is accompanied by an increase in nanofiber diameter, where the tensile strength of PI400 reaches 7.721 MPa, which is increased by 21.49% compared with 6.355 MPa of PI16-80-10. However, the elongation at break of PI400 is decreased from 25.60% of PI16-80-10 to 19.02%, which is decreased by 25%. A comparison of appearance before and after bending is shown in FIG. 2(c).
(3) Thermal properties of materials, including stability and phase transition, were determined using a Netzsch STA449F3 Jupiter simultaneous thermal analyzer of Germany. Samples were heated from 30° C. to 800° C. under a nitrogen atmosphere at a heating rate of 20° C./min without heat preservation. This method allows evaluation of thermal degradation behaviors of the materials and identification of any phase transition occurring during heating.

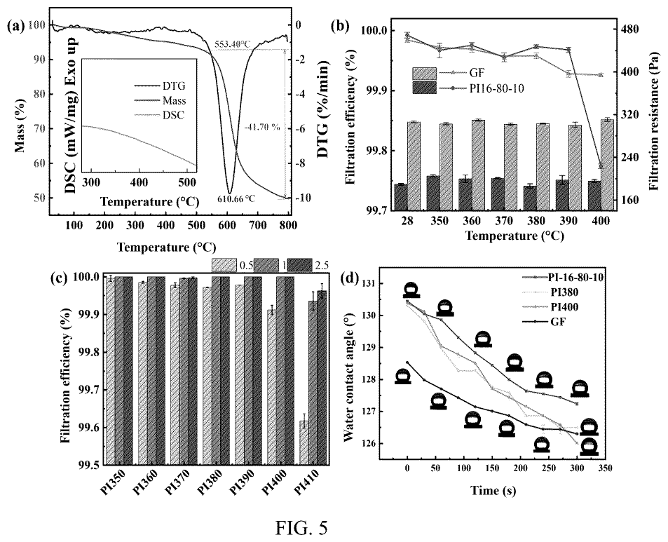

Thermal stability is one of key factors when addressing fundamental issues in filtration of particulate matter in a high-temperature environment. As shown in FIG. 5(a), a fine-diameter PI nanofiber membrane was characterized by thermogravimetric analysis (TGA). Results reveal that the membrane has minimal mass change within a temperature range of 30-180° C., which is attributed to the removal of a remainder of an organic solvent. When the temperature is raised to 553.40° C., significant mass loss occurs, which is caused by self-crosslinking, cyclization, and dehydrogenation reactions of the membrane. A differential thermogravimetric analysis (DTG) curve shows that the fine-diameter PI nanofiber membrane has a main weight loss temperature of 610° C., and the loss is mainly caused by an oxidation effect of continuously released carbon and carbon monoxide. Therefore, the fine-diameter PI nanofiber membrane exhibits good thermal stability below 550° C. A differential scanning calorimetry (DSC) curve shows no significant peak between 300° C. and 500° C., further providing excellent thermal stability of the fine-diameter PI nanofiber membrane. However, as a filtration material, its abilities to maintain filtration efficiency and avoid failure at high temperature are of greater practical significance.
(4) A temperature-resistant filtration test was carried out using a KJ-T1200-S6010-wQ vacuum tube furnace of Zhengzhou Kejia Electric Furnace Co., Ltd. To simulate real high-temperature conditions, samples were heated to 410° C. in air at a rate of 10° C./min, subjected to isothermal heat preservation for 1 h at every 10° C. within an interval of 350° C. to 400° C., and then measured from 350° C. to 410° C. to obtain filtration efficiencies and resistances at different temperatures.

Filtration performance of membranes was evaluated on an LZC-K1 filter material comprehensive performance testing platform of Jiangsu Suzhou Huada Instrument Equipment Co., Ltd., China. The membranes were placed in a circular clamp with a diameter of 11 cm, and their filtration efficiencies and resistances were measured at different air speeds by adjusting the flow rate. The filtration efficiency of a filter is calculated using the following formula:

$$η = ( 1 - \frac{{C}_{down}}{{C}_{u p}} ) \times 100$$

where η refers to filtration efficiency; and C_{down} and Cᵤₚ refer to particle number concentrations at the downstream and upstream of the filter, respectively.

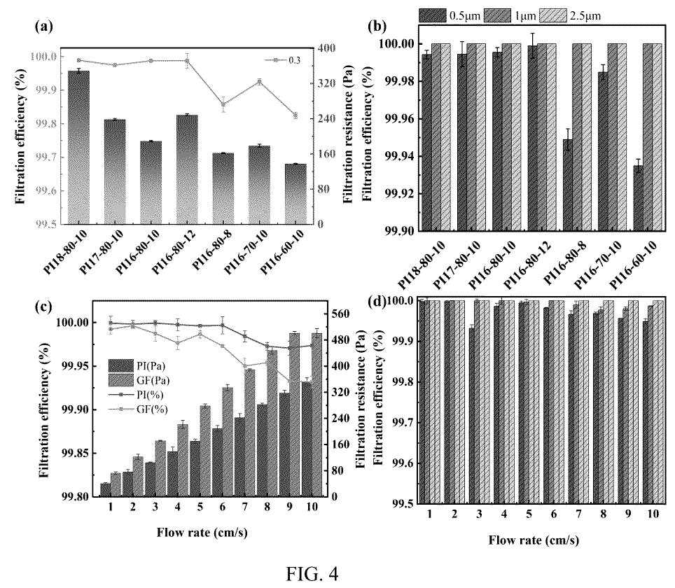

During analysis of filtration performance of fine-diameter PI nanofiber membranes, in-depth analysis was mainly performed on the filtration efficiency for PM0.3. As shown in FIG. 4(a) and FIG. 4(b), the PI16-80-10 sample exhibits significant superiority. The filtration efficiency of PI16-80-10 reaches 99.98753%, and compared with 99.989% of the PI18-80-10 sample and 99.97466% of the PI17-80-10 sample, the three are all greater than 99.95%, achieving high-efficiency filtration for PM0.3. According to the filtration efficiency for PM2.5, all the samples can achieve complete filtration. However, PI16-80-10 shows an advantage in resistance. In terms of filtration resistance, the PI16-80-10 sample has a resistance of 189.18 Pa, and compared with 348.86667 Pa of the PI18-80-10 sample and 238.74 Pa of the PI17-80-10 sample, the PI16-80-10 sample has the lowest filtration resistance. The PI15-80-10 sample was also tested. Due to a spindle-like structure and extensive fiber bonding and sheet coverage on the surface, the filtration efficiency of PI15-80-10 reaches 99.99%, but its filtration resistance is extremely high and reaches 500 Pa+. Due to a testing instrument, a test upper limit is 500 Pa.

Through further comparison of samples under different electrospinning times (such as PI16-80-12) and different electrospinning voltages (such as PI16-70-10), it is found that prolonging the electrospinning time does not improve efficiency but increases resistance. For samples at different voltages, such as PI16-70-10, although the filtration efficiency reaches 99.92495%, the resistance is 178.74 Pa.

To explore performance of a fine-diameter PI nanofiber membrane in practical applications, a filtration efficiency test was carried out under a series of air speed conditions, and compared with a commercial glass fiber filter material for analysis. As shown in FIGS. 4(c) and (d), at an air speed of 1 cm/s, the fine-diameter PI nanofiber membrane (PI16-80-10) reaches a filtration efficiency of 99.9993% for PM0.3, which is slightly higher than 99.9924% of the glass fiber filter material. As the air speed increases, although the filtration efficiency of the fine-diameter PI nanofiber membrane is slightly decreased, the efficiency for PM0.3 still remains at a high level of 99.9736% even at an air speed of 10 cm/s. In contrast, the efficiency of the glass fiber filter material is decreased from 99.9924% at 1 cm/s to 99.9317% at 10 cm/s.

In terms of filtration resistance, PI16-80-10 has a resistance of 40.7 Pa at the air speed of 1 cm/s, while the glass fiber filter material has a resistance of 72.5 Pa, indicating that the fine-diameter PI nanofiber membrane has lower air flow resistance under low air speed conditions. As the air speed increases, the resistance of PI16-80-10 is increased to 351.0 Pa, and is still lower than the resistance value (500.5+Pa) of the glass fiber filter material at the same air speed.

A temperature limit for maintaining high-efficiency filtration of a fine-diameter PI nanofiber membrane was investigated by comparing the fine-diameter PI nanofiber membrane with a commercial glass fiber under identical conditions, which may clarify a distance between the fine-diameter PI nanofiber membrane and a commercial high-temperature filtration material. In the experiment, the fine-diameter PI nanofiber membrane (PI16-80-10) and the commercial glass fiber were heated to 410° C. at a rate of 10° C./min, and subjected to isothermal heat preservation for 1 h at every 10° C. within an interval of 350° C. to 400° C. As shown in FIG. 5(b), within 350° C. to 400° C., the filtration resistance of the glass fiber is increased slightly from 302.63 Pa to 310.6 Pa. The filtration resistance of the fine-diameter PI nanofiber membrane reaches a peak value of 205.3 Pa at 360° C., but is decreased to 195.7 Pa at 400° C., and as the temperature increases, the filtration resistance is decreased.

In terms of filtration efficiency, as the temperature increases, the filtration efficiencies of the glass fiber and the fine-diameter PI nanofiber membrane are both decreased. The filtration efficiency of the glass fiber is decreased from 99.98% at 28° C. to 99.92% at 400° C., with a changing amplitude of 0.06%. The filtration efficiency of the fine-diameter PI nanofiber membrane is decreased from 99.99% at 28° C. to 99.77% at 400° C., with a changing amplitude of 0.21%. As shown in FIG. 5(c), although fine-diameter PI nanofiber membranes have operated at a high temperature of above 350° C. for 6 h when reaching 400° C., their filtration efficiencies are decreased to a level that is unable to achieve high-efficiency filtration for PM0.3 particles and still able to ensure complete filtration for PM2.5. When the temperature reaches 410° C., PI410 still reaches a filtration efficiency of 99.96% for PM2.5.
(5) A surface contact angle test was carried out to evaluate surface wettability of membranes using a JCY-2 contact angle measuring instrument of Shanghai Fangrui Instrument Co., Ltd. The membranes were cut into rectangular pieces of 1×1 cm² and dried in a drying oven at 60° C. for 2 h. 2 L of water droplets were dropped on surfaces of the membranes to measure a contact angle (CA), which is an indicator of hydrophobicity or hydrophilicity of a material. Each test was carried out with three parallel controls to ensure the accuracy and reproducibility of results.

As shown in FIG. 5(d), a glass fiber (GF) exhibits excellent hydrophobicity and has an initial contact angle of 128.53°, and as the time prolongs, the contact angle is slightly decreased to 126.290 at 300 s, indicating that its hydrophobicity is slightly decreased, but remains stable in general. For fine-diameter PI nanofiber membranes and samples at different heat treatment temperatures, their initial contact angles are all close to 130°, showing extremely strong hydrophobicity. A decrease in contact angle within an observation time is small, indicating that PI has relatively stable hydrophobicity. Particularly, the contact angle of the PI400 sample is stabilized at 126.00°, which is slightly decreased compared with 127.23° of the PI16-80-10 sample, but the decrease is not great. Although having slight differences in initial contact angle, the PI samples at different heat treatment temperatures exhibit similar hydrophobicity, suggesting that the heat treatment temperature has little influence on the hydrophobicity of PI. Enhanced hydrophobicity of the fine-diameter PI nanofiber membranes is attributed to high-temperature imidization treatment at 350° C., and this process removes a hydrophilic —NH— group, thereby increasing a hydrophobic angle. On the other hand, although the diameters of nanofibers are increased as the heat treatment temperature increases, diameter ranges still remain 120 nm to 165 nm. The finer nanofibers in the present invention lead to the formation of smaller fiber pore sizes. Due to the smaller pore sizes, the water droplets on the surfaces of the nanofibers have greater tension, thereby significantly increasing the water contact angles of the surfaces of the fine-diameter PI nanofiber membranes compared with 100° to 110° observed in other studies.

Therefore, by adopting the preparation method and use of a polyimide nanofiber membrane with the above structure in the present invention, the polyimide nanofiber membrane prepared has the advantages of high filtration efficiency, low resistance, good thermal stability, and hydrophobicity, thus having a broad application prospect in the field of high-temperature filtration of PM.

Finally, it should be noted that the above examples are provided solely to illustrate the technical solutions of the present invention and are not for limitation. Although the present invention has been described in detail with reference to preferred examples, those of ordinary skill in the art should understand that modifications or equivalent substitutions may still be made to the technical solutions of the present invention, and these modifications or equivalent substitutions shall not make the modified technical solutions depart from the spirit and scope of the technical solutions of the present invention.

1. A method for preparing an ultrafine polyimide nanofiber membrane, comprising the following steps:
(1) formulation of a polyamic acid solution:
dissolving 4,4′-oxydianiline in N,N-dimethylacetamide to obtain a transparent 4,4′-oxydianiline/N,N-dimethylacetamide solution after the 4,4′-oxydianiline (ODA) is completely dissolved; and adding a pyromellitic dianhydride monomer into the 4,4′-oxydianiline/N,N-dimethylacetamide solution in multiple portions, stirring the solution to enable a full reaction between the 4,4′-oxydianiline and the pyromellitic dianhydride monomer, and allowing to stand to obtain the polyamic acid solution;
(2) subjecting the polyamic acid solution to electrospinning using a metal wire-type needleless process; and
(3) after completion of the electrospinning, performing drying to obtain a polyamic acid (PAA) nanofiber membrane, and then performing thermal imidization to obtain a polyimide nanofiber membrane.

2. The method for preparing an ultrafine polyimide nanofiber membrane according to claim 1, wherein a formulation process of the solution in the step (1) is carried out under a nitrogen protection condition at 0-5° C.

3. The method for preparing an ultrafine polyimide nanofiber membrane according to claim 1, wherein the polyamic acid solution in the step (1) has a concentration of 15-20 wt %.

4. The method for preparing an ultrafine polyimide nanofiber membrane according to claim 1, wherein the metal wire-type needleless electrospinning process in the step (2) is adopted as follows: a voltage is 60-80 kV, a distance from an electrospinning electrode to a carrier is 240 mm, and a distance from a collecting electrode to the carrier is 20 mm; an operating distance of a pipetting cart is 350 mm, a cycle time is 6 s, and an electrospinning time is 8-12 min; and a spinning temperature is 15° C.-25° C., and humidity is 30%-50%.

5. The method for preparing an ultrafine polyimide nanofiber membrane according to claim 1, wherein the thermal imidization in the step (3) comprises specific steps as follows:
placing the dried PAA nanofiber membrane in a muffle furnace, heating from room temperature to 350-400° C. at 1-2° C./min under air conditions, performing heat preservation respectively at 100° C., 200° C., 300° C., and 350° C. for 1 h, and then naturally cooling to room temperature to obtain the polyimide nanofiber membrane.

6. An ultrafine polyimide nanofiber membrane, prepared by the preparation method according to claim 1.

7. The ultrafine polyimide nanofiber membrane according to claim 6, wherein the polyimide nanofiber membrane has an average fiber diameter of 100-400 nm.

8. Use of an ultrafine polyimide nanofiber membrane according to claim 6, wherein the ultrafine polyimide nanofiber membrane is used in high-temperature filtration of fine particulate matter.
